(19) United States
(12) Patent Application Publication
(10) Pub. No.: US 2021/0292065 A1
(43) Pub. Date: Sep. 23, 2021

(54) FILM FROM WHICH PACKAGING CAN BE MANUFACTURED, IN PARTICULAR FOR FOODSTUFFS, OPTICAL GLASSES, INDIVIDUAL PARTS FOR BIOREACTORS, SOLAR PANELS OR THE LIKE

(71) Applicant: Südpack Verpackungen GmbH & Co. KG, Ochsenhausen (DE)

(72) Inventors: Carolin Grimbacher, Ochsenhausen (DE); Jürgen Betz, Steinhausen an der Rottum (DE); Peter Brass, Steinhausen an der Rottum (DE)

(21) Appl. No.: 17/208,263

(22) Filed: Mar. 22, 2021

(30) Foreign Application Priority Data
Mar. 23, 2020 (EP) 20 164 815.1

(51) Int. Cl. B65D 65/40

(52) U.S. Cl. CPC B65D 65/40; B29C 48/08

(57) ABSTRACT

In the case of a film (1) from which packaging (2) can be manufactured, in particular for foodstuffs (3), optical glasses (4), individual parts for bioreactors, solar panels or the like, medical devices, pharmaceutical products or the like, the film (1) consists of at least two polymer layers which are joined together in a co-extension die (7) to form the film (1), the film (1) should already have a sterile or at least particle-free surface during the manufacturing process, which surface is reliably protected against contamination of all kinds during the transport and storage times of the film (1). This is achieved in that an additive (8) is present in one of the layers in a dosable amount and/or in that the material pairing between the first and second layers (5₁, 6₁) has a low adhesion force, and in that the first and second layers (5₁, 6₁) can be non-destructively detached from one another in a separating plane (15), in such a way that the film (1) can be divided into two film webs (11, 12).

### REFERENCE TO PENDING PRIOR PATENT APPLICATION

This patent application claims benefit of European Patent Application No. 20 164 815.1, filed Mar. 23, 2020, which patent application is hereby incorporated herein by reference.

### FIELD OF THE INVENTION

The invention relates to a film from which packaging can be manufactured, in particular for foodstuffs, optical glasses, individual parts for bioreactors, solar panels or the like, medical devices, pharmaceutical products or the like, according to the pre-characterising clause of Patent claim 1.

### BACKGROUND OF THE INVENTION

Such films are usually manufactured in a co-extrusion process. In this process, different polymers in the form of granules are filled into a co-extension die, fed into a screw conveyor in which the polymer granules are heated and compacted by friction, and then the individual polymer layers are joined together in the co-extension die in the form of a belt so that a film with different layers is produced.

Each of the layers can consist of a material which has the desired properties in order subsequently to provide packaging for the aforementioned objects after the film has been finished. Alternatively, the film can also be produced in what is referred to as a blowing process with an identical sectional structure.

Since the film often has to be unwound from a roll in further processing steps after production, and then rolled up for transport and storage purposes, dirt particles or other impurities can adhere to the free surfaces of the film and damage the extremely sensitive objects to be packaged, in particular foodstuffs or optical glasses.

Foodstuffs and pharmaceutical products in particular must also be packaged in an environment that is as dust-free as possible and often also sterile, in order to allow the sensitive items to be stored permanently or to ensure that they will not be contaminated and therefore become unusable. The surface of the film facing the items to be packed must therefore be kept free of particles, or sterile.

In order to achieve such a particle-free or even sterile surface of the film, it is a disadvantageous characteristic of the current state of the art that the film has to be unwound from the roll in a sterile environment, then cleaned completely, i.e. to make it particle-free or to sterilise it, in order then immediately to produce packaging for the foodstuffs, optical glasses or pharmaceutical products from the film cleaned in this manner. Immediately after the surface of the film has been cleaned, it should therefore be used in the particle-free or sterile environment. However, such cleaning work is extremely time-consuming and consequently cost-intensive. Moreover, the handling of such a film is complicated and enormous medical and professional skills are required of the respective users of such a film in order to ensure that the surface of the film is cleaned in accordance with the legal standards.

If dirt particles remain on the surface of the film during transport or storage, the film can no longer be used for packaging optical glasses or solar panels, because such dirt particles can destroy the extremely sensitive surface structure of the optical glasses or solar panels. As soon as even the smallest scratches, or other damaging effects, occur on the glass surfaces of such objects, these optical glasses are rendered unusable. Consequently, the films used as packaging in this way have an enormous technical requirement to cover such sensitive surface structures during their storage and transportation, and to protect them from damage or other contamination.

### SUMMARY OF THE INVENTION

It is therefore the task of the present invention for a film of the aforementioned type to be developed in such a way that it already has a sterile or at least particle-free surface during the production process, which surface is reliably protected against contamination of all kinds during the transport and storage times of the film, and that a film formed in this way can thus be used immediately before its use for the respective packaging, without additional cleaning or sterilisation work being necessary.

This task is solved in accordance with the present invention by the features of the characterising part of Patent claim 1.

Further advantageous embodiments of the present invention are derived from the subordinate claims.

In that an additive is present in one of the layers in a dosable amount and/or in that the material pairing between the first and second layers has a low adhesion force, and in that the first and second layers can be detached from one another in a separating plane in a non-destructive manner in such a way that the film can be divided into two film webs, it is ensured that the surface of the film which subsequently faces the object to be packaged in the form of foodstuffs, optical glasses, solar panels, pharmaceutical products or other medical devices is permanently protected from contamination, in particular by dirt particles, since this surface is permanently sealed or covered.

Since the film produced in this way has a separating plane, it is also possible to produce two film webs from the one film by peeling, each of which can be used for a separate purpose. The layers of the two film webs can be identical or completely different, with the effect that each film web can be assigned an individual predefined packaging property.

By dividing the film into at least two or even more film webs constructed in this way, several uses can thus be made available by a film prefabricated by the manufacturer.

Consequently, two or more film webs can advantageously be joined together in a manufacturing process, between which one of the separation planes is provided in each case, so that the film comprises a plurality of film webs which can be separated from one another in a non-destructive manner. Each of the film webs can have different thermodynamic or other physical properties in order to optimally protect the objects to be packaged from damage, contamination or other environmental influences. The film webs are separated from one another in such a way that an additive is incorporated in a predetermined amount in at least one of the layers forming the film web, by means of which the adhesive forces between the film webs are predetermined. Accordingly, a certain manual or mechanical peeling force is required to separate the film webs from one another in the separation plane. In addition, the respective sheet of the layers facing the separation plane can also have a pairing of materials that form low adhesion forces with one another.

### BRIEF DESCRIPTION OF THE DRAWINGS

The drawings show a sample embodiment of a film with various polymer layers in accordance with the present invention, the details of which are explained below. In the drawings:

FIG. 1 shows a schematic co-extension die, in which different polymers are heated and liquefied, by means of which a film comprising two layers forming a parting plane is formed, in such a way that the layers can be separated from one another in a non-destructive manner, as a sectional view,

FIGS. 2a show the film according to FIG. 1 with the two layers, in to 2c each of which there are different sheets of polymer,

FIG. 2d shows the film according to FIG. 1 with the two layers having identical structures, and

FIGS. 3a show various applications for the film according to FIGS. 1, to 3c which is constructed in two film webs with different or identical sheets.

### DETAILED DESCRIPTION OF THE PREFERRED EMBODIMENTS

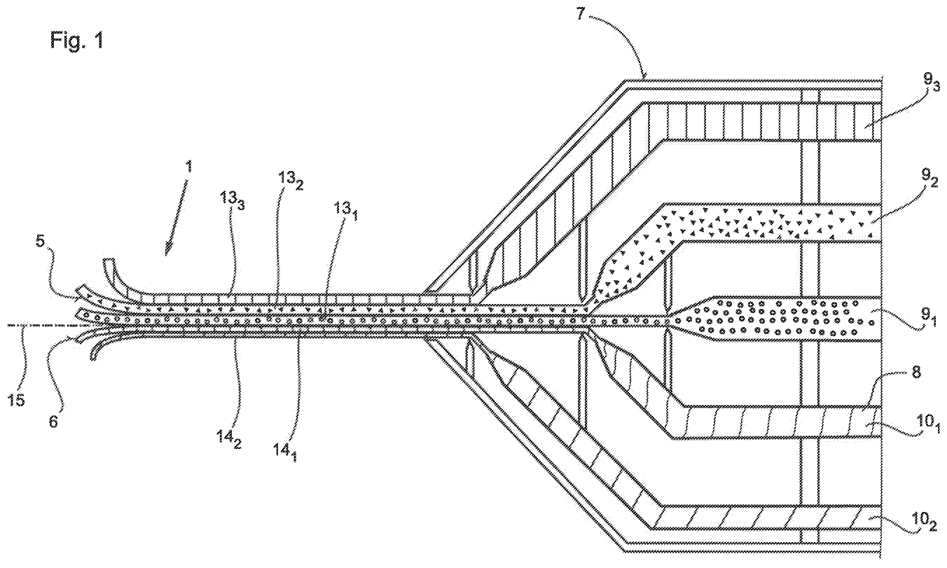

FIG. 1 shows a schematic diagram of a co-extension die 7 in which different polymers 9₁-9ₙ and 10₁-10ₙ are filled. These polymers 9₁-9ₙ and 10₁-10ₙ can be made of different materials. The respective polymers 9₁-9ₙ are associated with a film 1 having an upper layer 5, and the polymers 10₁-10ₙ are associated with a lower layer 6 of the film 1. The respective polymers 9₁-9ₙ and 10₁-10ₙ are joined together in a co-extrusion process in the die 7. The parting plane between the two layers 5 and 6 is marked with the reference numeral 15.

In particular, an additive 8 is admixed to the polymers 10₁ of the layer 6. Once the polymers 9₁-9ₙ and 10₁-10ₙ have been joined together in the die 7 due to heating and leave the die 7, the film 1 is formed. In this case, the film 1 comprises the two layers 5 and 6 separated from one another by the separation plane 15, each of which comprises a plurality of sheets 13₁, 13₂-13ₙ and 14₁, 14₂-14ₙ, respectively. This is because any number of polymers 9₁-9ₙ and 10₁-10ₙ can be joined together in the die 7. In this case, the innermost sheet of the layer 5 facing the separation plane 15 is marked with the reference number 13 and the innermost sheet of layer 6 in relation to the separation plane 15 is marked with the reference number 14₁, and the sheets further away from the separation plane 15 are marked with a higher ordinal number.

The joining of the polymers 9₁-9ₙ and 10₁-10ₙ, respectively, is carried out in a particle-free or sterile environment, since impurities are not present inside the die 7 due to the high temperatures prevailing there.

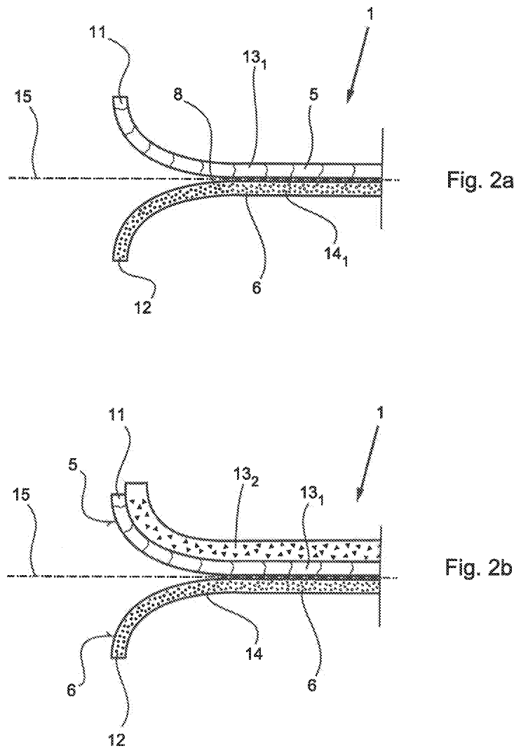

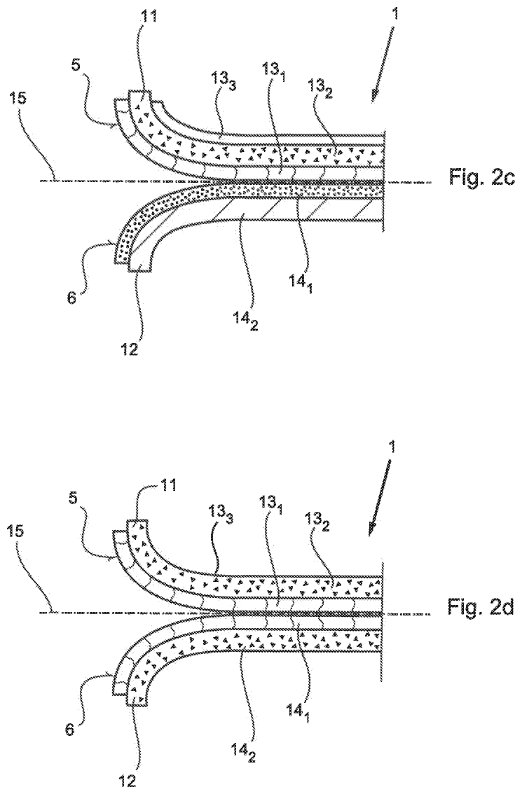

In FIG. 2a, the film 1 is composed of two layers 5 and 6, each having a sheet 13₁ and 14₁, respectively. In this regard, the additive 8 is mixed into the sheet 14₁, in a predetermined amount. After the film 1 has been finished, the sheet 13₁ can be non-destructively detached from the sheet 14₁ to form two film webs 11 and 12 corresponding to the original layers 5 and 6, respectively.

As the layers 5 and 6 are joined together inside the die 7 in a sterile, at least particle-free environment, the facing surfaces of the sheets 13₁ and 14₁ completely bond and seal together. Accordingly, no dirt particles can reach these surfaces of the film webs 11 and 12 during the storage and transport status of the film 1. Furthermore, the film 1 can be wound on a roll 16 for storage and transportation purposes. During the processing process of the film 1, it often has to be unwound from the roll 16 and processed several times. By unwinding the film 1 from the roll 16 and during the processing, the surfaces of the layers 5 and 6 are bonded to each other, so that no dirt particles or other impurities can reach the surface of the film webs 11 or 12 facing the separation plane 15 during this processing phase.

FIG. 2b shows a film 1 with the two layers 5 and 6. The layer 5 now consists of two sheets 13₁ and 13₂, which are made of different polymers.

Accordingly, the physical property of the film webs 11 is different from the physical property of the film web 12. Nevertheless, the layers 5 and 6 can be non-destructively detached from each other in the common separation plane 15 to produce the film webs 11 and 12, respectively.

In FIG. 2c, layer 5 consists of three sheets 13₁, 13₂ and 13₃ and layer 6 consists of two sheets 14₁ and 14₂, each of which comprises or is formed from different polymers. In this regard, a particular use of the film web 11 is, for example, to use it to provide packaging 2 for a foodstuff 3 comprising an oxygen scavenger sheet 13₂. The scavenger component can in principle also be arranged in a further outer sheet 13₃ or 13₄. Then, a barrier should be provided in sheet 13₂ or 13₅, that is, spatially separated from the separation plane 15. Technically speaking, the attempt would be made to insert a scavenger sheet 13₁ in such a way that it can react with oxygen as quickly as possible after activation.

Consequently, a combination of a scavenger sheet 13₁ and a barrier layer 13₂ should be provided to first protect the scavenger component so that it cannot react and so it retains its original composition.

The reaction start time, from when the sheet 13₁ absorbs oxygen, cannot normally be determined precisely. The reaction begins as soon as oxygen reaches this sheet 13₁. However, the absorption capacity of such an oxygen-absorbing sheet 13₁ is limited, so that the manufacturer of a foodstuff 3 often desires the reaction start time for oxygen absorption to begin immediately at the packaging time of the foodstuff 3. Such a predetermined start of the reaction start time or oxygen absorption has not been possible up to now; this goal is only achieved with the layer structure explained above of the respective layer 5, 6 and its sealing agent of the second layer 6. The layer 6 contains an oxygen barrier and thus protects the scavenger from an unwanted reaction with oxygen in this embodiment of the sheet 13₁. Therefore, an oxygen barrier must also be provided in layer 5, seen from the outside in front of the scavenger.

Since now the sheet 13₁ is formed of an oxygen absorbing or binding substrate, for example scavenger, which is completely covered by the layer 6 and moreover both the layer 5 and the layer 6 of the film 1 comprise an oxygen barrier sheet 13₁ and 14₂ respectively, the oxygen absorbing sheet 13₄ is completely protected from the supply of oxygen during the transport and storage status. Thus, an adjustable reaction start time only occurs when the film web 12 is removed from the film web 11, and the film web 11 can be used immediately thereafter as packaging for the foodstuff 3.

In FIG. 2d, the structure of the layers 5 and 6 is identical, so that there are two film webs 11 and 12 with identical physical properties.

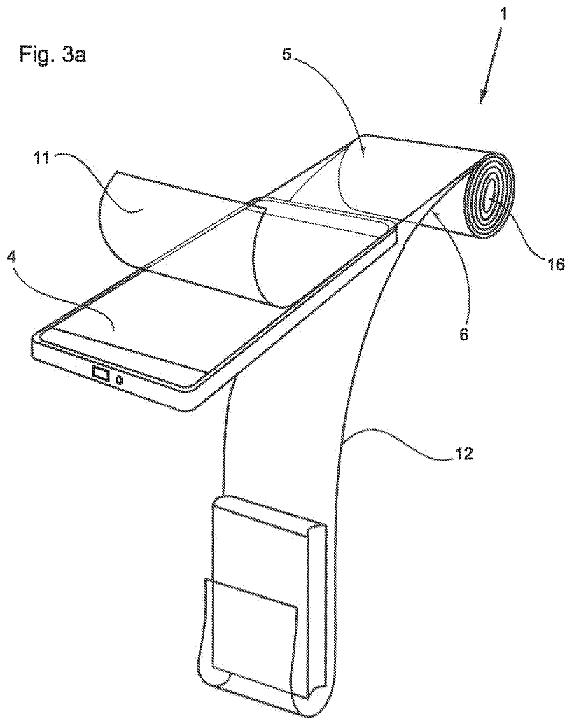

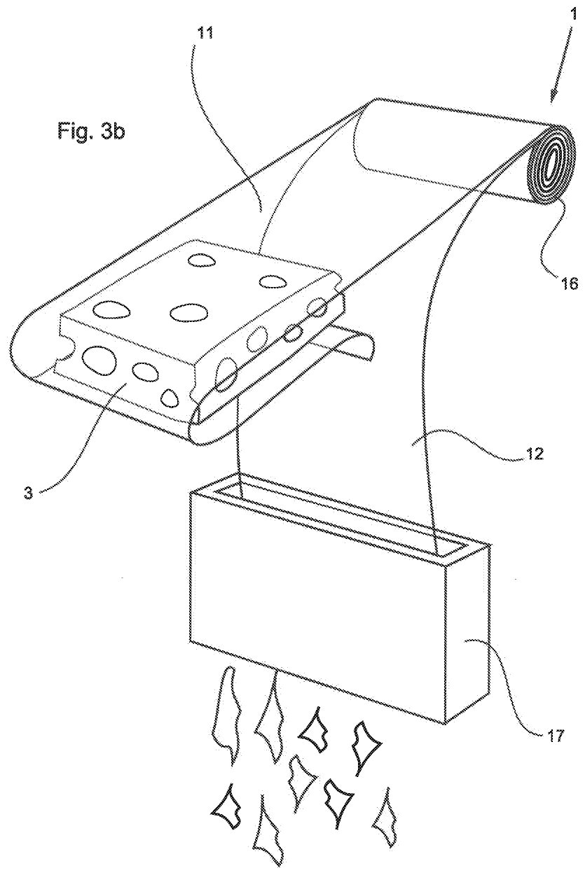

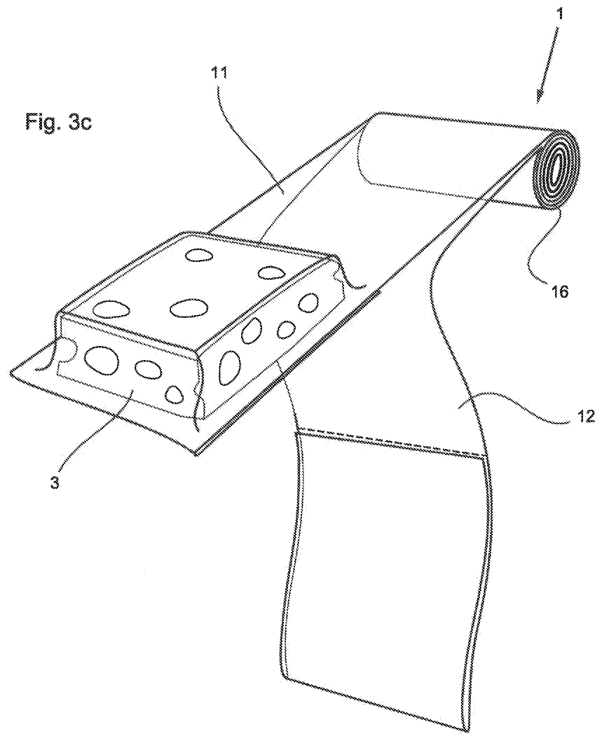

FIG. 3a shows how the film 1 is unwound from the roll 16 and immediately separated non-destructively into the two film webs 11 and 12. In this regard, the film web 11 with its particle-free surface can be placed directly on a glass panel of an iPhone so that no contamination occurs between the electrical device or its glass surface and the particle-free surface of the film web 11. The film web 11 can be used in an identical manner for packaging pharmaceutical products, solar panels, medical devices requiring sterile wrapping, furthermore packaging for individual parts of or for bioreactors also to be enclosed, or the like. This is merely an exemplary representation.

The film web 12 can be put to another use, for example to package newspapers, magazines or other products to be protected against rainwater, which have a lower requirement on the surface composition of the film web 12.

FIG. 3b shows that the film web 11 has its particle-free surface facing the foodstuff 3 in order to seal it in a completely airtight and watertight manner. The film web 11 can also be deep-drawn or perforated in some other way, if this is desired by the customer.

The film web 12 comprises a material or combination of materials that is recyclable or that comprises recycled material. This is schematically represented by the recycle apparatus 17.

FIG. 3c shows that identical film webs 11 and 12 can be used simultaneously to package a foodstuff 3.

To simplify the separation of the film webs 11 and 12, it may be advantageous if the first sheet 141 of the layer 6 facing the separation plane 15 has a thinner wall thickness than the subsequent sheets 14₂-14ₙ in the layer 6, as this may reduce the adhesive forces required for separation.

The polymers 9₁-9ₙ and 10₁-10ₙ for layers 5 and 6, respectively, are formed from polyolefin materials LDPE, LLDPE, mLLDPE, HDPE, PPCopo or PPhomo. Furthermore, the sheets 13₁-13ₙ and 14₁-14ₙ of the layers 5 and 6 can be formed of a thermoplastic polymer, for example the aforementioned one. The separation layer 15 has a polymer pairing of the materials of the polyolefins, in particular a pairing of polyolefin/PA, polyolefin/EVOH, polyolefin/PET or GPBET/PE. An adhesion promoter is usually provided between these layers, this is also polyolefinic.

In addition, antistatic or other surface-active substances can be mixed into the sheets 13₁ and 14₁ facing the separation plane 15. Such substances are to be adapted to the intended use of the respective film web 11 or 12, so that, for example, electrical devices, accumulators, other electrically conductive components can also be stored antistatically by the respective film web 11 or 12.

What is claimed is:

1. A film (1) from which packaging (2) can be manufactured, in particular for foodstuffs (3), optical glasses (4), individual parts for bioreactors, solar panels or the like, medical devices, pharmaceutical products or the like, consisting of at least two polymer layers which are joined together in a co-extension die (7) to form the film (1),
characterized in that,
an additive (8) is present in one of the layers in a dosable amount and/or in that the material pairing between the first and second layers (5₁, 6₁) has a low adhesion force, and in that the first and second layers (5₁, 6₁) can be non-destructively detached from one another in a separating plane (15), in such a way that the film (1) can be divided into two film webs (11, 12).

2. The film according to claim 1,
characterized in that,
the layer structure of the two layers (5, 6) has an identical structure.

3. The film according to claim 1,
characterized in that,
the second layer (6) consists of several different sheets (14₁, 14₂, . . . 14ₙ) and that the first sheet (14₁) facing the separation plane (15) has a thinner wall thickness than the subsequent sheets (14₁, 14₂, . . . 14ₙ).

4. The film according to claim 1,
characterized in that, within one of the two layers (5, 6), at least one oxygen-barrier sheet (13₁ or 14₂) and an oxygen-binding substrate sheet (13₂ or 14₃) are incorporated in one or both layers (5, 6), and/or that this oxygen-barrier sheet (13₁ or 14₂) is covered or enclosed by at least one further sheet (13₂ or 14₃) which is spaced further away from the separation plane (15).

5. The film according to claim 4, characterized in that, the oxygen barrier (13₃, 14₃) is formed from the materials EVOH, PLA, PVOH, PA or PET.

6. The film according to claim 4,
characterized in that,
in that the polymers (9₁ to 9ₙ or 10₁ or 10ₙ ) are formed from a polyolefin material for the respective sheets (13₁. . . 13ₙ , 14₁. . . 14ₙ) as LDPE, LLDPE, mLLDPE, HDPE, PPhomo or PPCopo, and that the layer structure of the first layer (5) has different sheets (13₁. . . 13ₙ) of these materials, which are optionally (13₁. . . 13ₙ) separated by sheets of another polymer material.

7. The film according to claim 1,
characterized in that,
the respective first sheet (13₁; 14₁) of the two layers (5, 6) facing the separation plane (15) is formed from a polymer pairing or mutually incompatible polymers which have no or low adhesive forces, preferably from the material pairings polyolefin/PA, polyolefin/EVOH, polyolefin/PET or GPET/PE.

8. The film according to claim 1,
characterized in that, a surface-active substance is added in one of the layers (5 or 6), by means of which the adhesive forces between the layers of the two sheets (13₁; 14₁) lying apart from one another are increased or reduced.

9. The film according to claim 1,
characterized in that,
after the two layers (5, 6) have been separated from one another, the two independent film webs (11, 12) are formed, each of which can be fed to a different purpose or area of use, and in that the respective surfaces of the film webs (11, 12) facing one another before the separation are particle-free and/or sterile.

10. The film according to claim 1,
characterized in that, polysorbate 40, 60, 65 or 80 as well as Tagat or Tween 20 or 80 are incorporated as surface-active substances in one of the sheets (13₁ or 14₁) of the layers (5, 6).
